(19) United States
(12) Patent Application Publication
(10) Pub. No.: US 2002/0114606 A1
(43) Pub. Date: Aug. 22, 2002

(54) Manufacturing method of a device for attenuating a signal carried by an optical fiber, attenuation device, attenuation system and corresponding applications

(76) Inventors: Jean-Louis De Bougrenet, Saint-Renan (FR); Laurent Dupont, Plouzane (FR); Philppe Chanclou, Louannec (FR)

Correspondence Address: Robert M. Angus, Westman, Champlin & Kelly, International Centre, 900 Second Avenue South, Suite 1600, Minneapolis, MN, 55402-3319, US

(21) Appl. No.: 10/076,062

(22) Filed: Feb. 13, 2002

(30) Foreign Application Priority Data
Feb. 13, 2001 (FR) 01 01967

(51) Int. Cl. G02B 6/26; G02B 6/255; G02B 6/38; G02F 1/13

(52) U.S. Cl. 385/140; 385/95; 385/73; 349/193

(57) ABSTRACT

An attenuation device for a signal carried by an optical fiber in the form of a light signal is manufactured. The optical cores of a first and a second single-mode fiber are expanded. The first and second fibers are assembled facing each other in a capillary containing a liquid crystal. The liquid crystal is polymerized to produce an attenuation element. The resulting attenuation device comprises a first and a second single-mode fiber with expanded optical cores assembled facing each other in a capillary containing a liquid crystal forming attenuation means.

### FIELD OF THE INVENTION

The field of the invention is that of the transmission of signals by optical fibers. More specifically, the invention relates to the manufacture of devices for attenuating a signal carried by an optical fiber, and the corresponding devices.

### BACKGROUND OF THE INVENTION

Optical attenuators are the key components in the present deployment of optical fiber transmission systems. Such attenuators are used for multiple purposes, such as, for example:

matching the optical power of a signal to the power sensitivity range of optical receivers;

adjustment of the output levels of optical amplifiers of the EDFA (Erbium Doped Fibre Amplifier) type;

power equalization between different WDM (“Wavelength-Division Multiplexing) channels;

testing the general performances of optical systems under variable optical power conditions.

Several technologies for designing variable optical attenuators (VOA) have already been developed, utilizing different physical effects occurring in materials.

Thus, utilization of the thermo-optic effect was contemplated, as in the VOA fiber of MOEC (registered trademark), or in liquid crystal materials such as in the E-tek JDS Uniphase (registered trademark) products.

These optical attenuators suffer from the drawbacks, for the first, of having significant power consumption and for the second, of requiring the use of a device with a variety of polarizations and of a very accurate temperature control. These multiple problems, as shown in particular in the documents of U.S. Pat. No. 6,130,984 entitled “Miniature variable optical attenuator” of Shen, Xu and Pan, and document U.S. Pat. No. 5,727,109 entitled “Optical attenuator with low polarization mode dispersion” of Pan and Shih, lead to a substantial increase in the manufacturing cost of such variable optical attenuators.

More recently, a new technology based on the use of micro-electro-mechanical systems (MEMS), has been successfully used by Sercalo Microtechnology (registered trademark). Indeed, these components have the advantage of having a very large attenuation dynamic range (of the order of 50 dB), of being insensitive to polarization, and of being very low in cost, typically of the order of $200 US.

However, such a technology has drawbacks related to the problem of mechanical wear of the MEMS.

The design of optical attenuators by means of random diffusers for which double refraction may be controlled by applying an electric field so as to modulate the transmission curve, has also been contemplated. Such components are known to be good optical attenuators, are a priori insensitive to polarization and have low consumption.

Two particular technological solutions are notably known for making VOAs from random diffusers. The first solution is for example described in the patent document U.S. Pat. No. 4,364,639 by Sinclair, Straus and Garel-Jones entitled “Variable Attenuation Electro-Optic Device”. It implements a doped liquid crystal of the MBBA/EBBA (N-(p′-methoxybenzylidene)-p-n-butylaniline/N-(p′-ethoxybenzylidene)-p-n-butylaniline) type, confined between two glass slides as described in document “Dynamic scattering: a new electro-optic effect in certain classes of nematic LC” by Heimer et al., Proc. SPIE Vol. MS 46, pp. 289-290, 1992. In such a device, as illustrated in FIG. 1, the optical beam is self-collimated by means of two collimating microlenses 10 and 11 of the self-focus type. The light signal carried by the single-mode optical fibers 13 and 14 is attenuated when it crosses the liquid crystal based device 15. The operating conditions consist of applying an alternate voltage parallel to the direction of propagation of the optical beam 12.

A drawback of this technique from prior art is that the obtained attenuation effect is weak, and it is therefore necessary to apply high electrical voltages to the terminals of the device in order to obtain sufficient attenuation of the signal.

Another drawback of this technique from prior art is that, because of the small size of the core of single-mode fibers (SMF), the interconnections have low alignment tolerances which makes the manufacturing of such an optical attenuator delicate. Introduction of lenses 10 and 11 further increases the complexity of such an assembly, and as a result, makes the whole more costly. Such a solution notably has large insertion and connection losses.

The second solution consists of using a polymer and liquid crystal mixture (PDLC for “Polymer Dispersed Liquid Crystal”) of the type described in document “Polymer Encapsulated Nematic LC”, Proc. SPIE Vol. MS 46, pp 510-512, 1992 by J. L. Fergason. With such a compound, variable optical attenuators may be made, which have a large dynamic range. Moreover, the association of the use of single-mode optical fibers with PDLC type components was notably suggested in document “Polarization independent optical fiber modulator by use of PDLC”, Applied Optics Vol. 37, pp. 3181-3189, 1998 by Takizama, Kodama and Kishi.

However, such an association has severe functional limitations, notably related to the low attenuation efficiency of such a device. Indeed, to obtain a sufficiently large attenuation of the incident beam, it is necessary to increase the thickness of the PDLC cell and therefore to increase the electrical voltage applied on the terminals of the cell, in frequently prohibitive proportions.

Nevertheless, both of the solutions described above are potentially low cost solutions which have the advantage of being insensitive to polarization, while providing the advantages from the use of liquid crystals, such as for example low energy consumption.

However, they are unable to meet the new specifications related to present telecommunications systems, and so they must be changed and adapted, notably in a low cost component rationale. In particular, they are unable to achieve sufficient attenuation dynamic range.

Furthermore, from document JP-11052339 (NTT), a process for manufacturing VOAs is known, according to which a strip of fibers is formed, positioned on a platform. The strip is then sawn to create a space, which is filled by the PDLC. This technique has the advantage of making it possible to produce several devices simultaneously (the filling of the PDLC being able to be carried out collectively).

Nonetheless, this technique has proved to be of low efficiency in practice, the sawing producing surfaces of poor quality, capable of inducing optical losses and high pollution, due to the mechanical attack of the fiber. The sawing can furthermore provoke an incipient crack in the support platform, bringing about mechanical fragility. This can also introduce metallic pollution (due to the sawing of the metallized part) of the zone containing the liquid crystal, and can thus create a short circuit.

A further drawback of this technique is that it is difficult to position the fibers correctly (the distance between the fibers is only controlled by the thickness of the saw and it is difficult to control the alignment of the fibers) which also leads to optical losses.

Furthermore, the production of the platform, with precisely positioned V-grooves, obtained by engraving and masking techniques which are difficult to implement, turns out to be complex and costly.

The main aim of the invention is to overcome these drawbacks of prior art.

More specifically, an aim of the invention is to provide a simple and efficient manufacturing process for variable optical attenuation devices meeting specific constraints related to present telecommunications systems.

A particular aim of the invention is to implement a manufacturing process making it possible to manufacture VOAs which are simple and not very costly to design, assemble and implement.

A further aim of the invention is to provide such a process, producing compact and robust optical attenuation devices.

Another aim of the invention is to provide such a process, whose variable optical attenuation devices have a wide attenuation dynamic range.

A still further aim of the invention is to provide such a process making it possible to obtain variable optical attenuation devices which have a large range of use in temperature and independence with regard to polarization.

### SUMMARY OF THE INVENTION

These aims, together with others which will become apparent in the following, are achieved by means of a process for manufacturing an attenuation device for a signal carried by an optical fiber in the form of a light signal, comprising the following stages:

expansion of the optical core of a first and of a second single-mode fiber;

assembly of said first and second fibers facing each other, in a capillary containing a liquid crystal;

polymerization of said liquid crystal, to produce an attenuation element.

The implementation of a capillary containing a liquid crystal makes it possible to simplify the assembly and the settings considerably, the two fibers being guided precisely face to face. Thus auto-alignment is achieved.

It is to be noted that the capillary is filled with liquid crystal before the fibers are set in place, which makes it possible to carry out filling by capillarity, ensuring filling without any air bubbles and making it possible to drive out possible pollution (gaseous, liquid . . . ), in such a way as to obtain absolute purity of the liquid crystal.

Advantageously, the process according to the invention also comprises, after said expansion stage, a stage of:

depositing an electrode over at least one portion of the periphery and over at least one portion of the end of each of said fibers.

The deposit at the end of the fiber makes it possible to limit the control voltages of the attenuator.

Preferably, said expansion stage comprises a stage of assembly and fracture of at least two portions of fiber at the end of each of said single-mode fibers.

This fracture technique makes it possible to obtain a very high quality surface state, contrary to techniques involving sawing, and does not provoke either pollution or fragility.

In this case, said fiber portions advantageously comprise a portion of fiber with graded index and a portion of fiber in pure silica.

Preferably, said liquid crystal is a liquid crystal dispersed in a polymer (PDLC). Advantageously, said polymer dispersed liquid crystal is a nematic liquid crystal with negative anisotropy.

According to an advantageous embodiment of the invention, said polymerization stage implements a polymerization of said liquid crystal dispersed in a polymer by ultra-violet radiation.

Thus, the process according to the invention comprises in particular the following stages:

expansion of the optical core of two fibers by assembly and fracture of a fiber with graded index and of pure silica;

metallization of the periphery and of the end of said fibers;

insertion of first and second said metallized fibers facing each other in a capillary containing a liquid crystal;

adjustment of the distance between the ends of said fibers facing each other;

polymerization of said liquid crystal by ultraviolet radiation.

According to another advantageous variant of the invention, at least one part of the ends of said fibers facing each other is conductive and substantially transparent.

Advantageously, one can envisage a buffer block of step index multimode fiber being added to each of said ends of said first and second fibers facing each other, said block having an external diameter substantially equal to that of said first and second fibers.

According to another implementation variant of the invention, said expansion stage comprises a stage of diffusion of dopants from the optical core of a cleaved single-mode fiber.

Preferably, said single-mode fibers with expanded core are polarization preserving fibers.

According to another variant of the invention, said process comprises a stage for inserting means for controlling said attenuation means by an optical field.

The invention also concerns attenuation devices manufactured according to the process described above. Such an attenuation device of a signal carried by an optical fiber in the form of a light beam comprises a first and a second single-mode fiber with expanded optical core, assembled facing each other in a capillary containing a liquid crystal forming attenuation means.

Advantageously, at least one portion of the periphery and at least one portion of the end of each of said fibers is metallized.

Preferably, the ends of said fibers are obtained by fracture.

The invention also concerns applications of these attenuation devices for implementation of a power limiter which can be controlled by optical power or by a variable attenuator which can be voltage controlled.

Furthermore the invention concerns systems of attenuation of at least one signal carried by optical fiber in the form of a light beam, comprising at least two attenuation devices, the fibers of said at least two attenuation devices being positioned as a strip of fibers.

### BRIEF DESCRIPTION OF THE DRAWINGS

Other features and advantages of the invention will become more apparent upon reading the following description of a preferred embodiment, given as a simple illustrative and non-limiting example, and the appended drawings, wherein:

FIG. 1, as already described earlier, shows a simplified diagram of an optical attenuator from prior art implementing self-focus type collimating micro-lenses;

FIG. 2 shows an overview diagram of a micro-optics strip implemented in an attenuation system according to the invention;

FIG. 3 illustrates a schematic view of a micro-optic from FIG. 2, having a buffer area;

FIG. 4 shows an expanded core fiber of the TEC type which may be implemented in an alternative embodiment of the invention;

FIGS. 5a and 5b illustrate the operating principle of an optical attenuator according to the invention when it comprises a PDLC type crystal controlled by an electric field;

FIGS. 6a and 6b illustrate the operating principle of an optical attenuator according to the invention when it is controlled by optical power;

FIGS. 7a-7d illustrate the principle of an optical attenuator comprising a PDLC type component which may be controlled by both voltage and optical power simultaneously;

FIGS. 8a and 8b show examples of supports onto which an optical attenuation system according to the invention may be integrated;

FIG. 9 is a simplified flow chart illustrating the manufacturing process according to the invention, making it possible to obtain the devices of the preceding figures;

FIG. 10 shows a fiber after metallization, according to the process of FIG. 9;

FIG. 11 shows the assembly of optical fibers with the aid of a capillary, according to the process illustrated in FIG. 9.

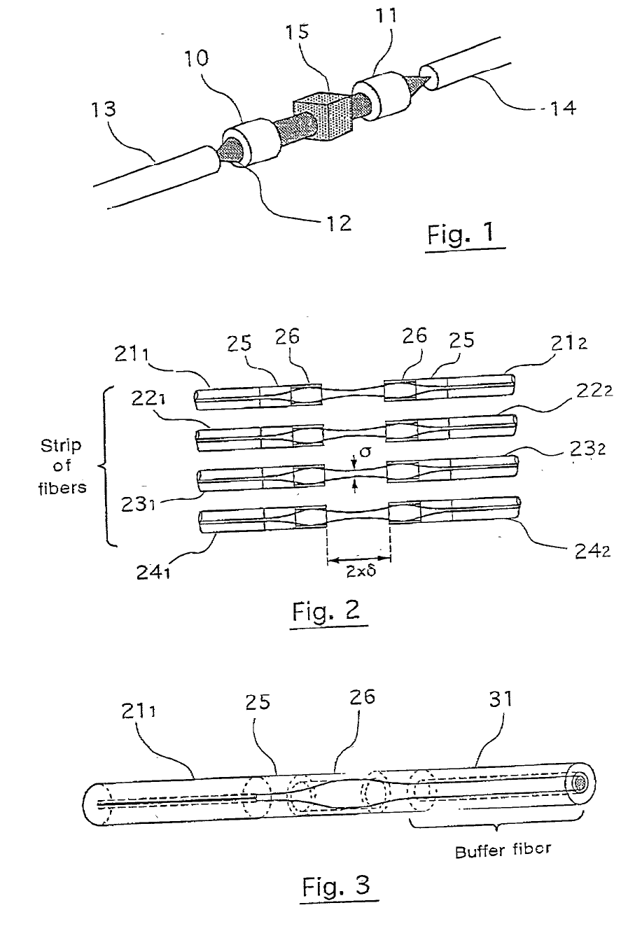

### DETAILED DESCRIPTION OF THE PREFERRED EMBODIMENTS

I. Structure of the Device Obtained According to the Invention

The general principle of the attenuation device produced according to the process of the invention is based on the combination of expanded core single-mode fibers and a PDLC type liquid crystal cell in order to make a compact variable optical attenuator having a large attenuation dynamic range.

I.1. Characteristics and Advantages of the Device.

A device obtained according to the invention comprises:

a first single-mode fiber with an expanded core, forming means for widening a section of said light beam;

a liquid crystal means for attenuating an energy associated with said widened light beam;

a second single-mode fiber, located opposite to said first single-mode fiber, said second fiber being of the expanded core type, so as to form means for reducing a section of said attenuated light beam,

and said liquid crystal being inserted in a cavity formed between said both single-mode fibers facing each other, said cavity being of a section substantially equal to the section of each of said expanded core fibers.

Thus, the invention is based on an approach for attenuating a signal carried by an optical fiber, providing the advantages of liquid crystals, while still having a good attenuation dynamic range, and great simplicity for assembling the device.

Indeed, the invention notably provides an optical attenuator comprising optical fibers with an expanded core, for widening the section of the incident optical beam on the liquid crystal and thereby providing better attenuation of optical power, while retaining a crystal liquid cell of small thickness.

The invention also provides the design of a liquid crystal cell with a section equal to that of the expanded core fibers forming the attenuation device; thus, the optical attenuation device according to the invention, has the advantage of being compact and very simple to manufacture. The alignment of the various constituent parts of the optical attenuator according to the invention is made very easy, all the parts being of a substantially identical section and the device thus designed being therefore more tolerant than the devices from prior art with regard to positioning errors of the fibers, which enables insertion losses to be reduced advantageously.

Advantageously, at least one portion of the ends of said fibers facing each other is conducting and substantially transparent.

The optical attenuation device according to the invention may thus be controlled by applying an electrical voltage to the conductive ends of the fibers facing each other, without however hindering the transmission of the light beam, these conductive ends being substantially transparent.

According to a first advantageous variant of the invention, each of said first and second expanded core fibers is made by adding, at least at one end of a single-mode fiber, at least one block with a nature different from that of said single-mode fiber, said at least one block being selected so that its external diameter is substantially equal to that of said single-mode fiber.

In fact, compactness and simplicity of assembly for the attenuation device of the invention are favored by ensuring that the parts which form it are of substantially equal sections.

Preferably, each of said first and second expanded core fibers is made by adding to at least one end of a single-mode fiber at least two blocks, of natures distinct from that of said single-mode fiber, and said at least two blocks comprising:

a silica fiber block;

a multimode fiber block with a graded index.

First and second special fibers including at their end, micro-optics comprising a graded index fiber section and a silica fiber section without any core, are thus designed. The size of the spot, and the distance separating both single-mode fibers facing each other in the device, may be adjusted by changing the length of both blocks of the micro-optic. Moreover, such a micro-optic may be protected and moved from the end of the single-mode fiber so as to allow surface treatments, such as for example depositing electrodes.

According to an advantageous embodiment of the invention, a buffer block of step-index multimode fiber is further added to each of said ends facing each other, of said first and second fibers, said block being selected so that its external diameter is substantially equal to that of said first and second fibers.

Such a buffer fiber may be inserted at the end of the micro-optic by welding, notably to facilitate the method for packaging the attenuator according to the invention.

According to a second advantageous variant of the invention, said two single-mode fibers with expanded core are made by diffusing dopants from the optical core of a cleaved single-mode fiber.

The expanded core single-mode fibers thus produced enable the section of the light beam to be widened or reduced, while having a constant external diameter.

Advantageously, said first and second single-mode fibers with an expanded core are fibers which preserve polarization.

According to an advantageous technique of the invention, said liquid crystal is a liquid crystal dispersed in a polymer (PDLC for Polymer Dispersed Liquid Crystal).

Thus, the making of a component consisting of a suspension of liquid crystal droplets in a host medium of the polymer type may be contemplated. In such a component, the orientation of the directors within the droplets is determined by interaction between the polymer and the liquid crystal at the interface. These orientations are generally distributed randomly in the absence of an electric field.

According to a first advantageous feature of the invention, such a device comprises means for controlling said attenuation means by an electric field.

Thus, by applying an electric voltage to the terminals of the liquid crystal cell, it is possible to influence the extent of the occurring diffusion phenomenon. If the liquid crystal is of the PDLC type, the difference between the relative refractive index of the liquid crystal and that of the polymer may thus be controlled and the PDLC may be caused to switch from an opaque state to a transparent state. The incident optical beam on the crystal is now attenuated, because of energy lost by diffusion upon crossing the liquid crystal.

Advantageously, at least one portion of the periphery of each of said first and second expanded core single-mode fibers is metallized, and said electric field is generated between two electrodes formed by each of said metallized portions of said fibers facing each other.

This technique is an alternative to the metallization of the ends of the fibers as described earlier.

According to a second advantageous feature of the invention, such a device comprises means for controlling said attenuation means by an optical field.

In fact, under strong illumination conditions (typically of the order of several hundred mW per 100 μm²), a reorientation of the director induced by the optical field is observed in a PDLC type crystal. An incident high power electromagnetic wave with any polarization, perpendicular to the propagation axis of the light beam, has the effect of orientating all the liquid crystal molecules of the PDLC in a same direction. The PDLC is then caused to be very strongly diffusing, and so the attenuation device according to the invention behaves as an optical power limiter.

A power limiter is thereby achieved at a reduced cost, as the power of the light beam may be attenuated without requiring a voltage to be applied to the terminals of the device.

Addition of a dopant to the liquid crystal of the PDLC in order to increase the non-linear effect which occurs therein, may also be contemplated.

I.2. Description of an Embodiment of a Device.

With reference to FIG. 2, an embodiment of a micro-optical strip is shown, as used in an attenuation system according to the invention.

As a reminder, according to the invention, such a system for attenuating a signal carried by an optical fiber as a light beam, comprises a plurality of attenuation devices, and the plurality of optical fibers implemented in these devices is positioned as a strip of fibers, as illustrated in FIG. 2.

The strip illustrated in FIG. 2 comprises 4 pairs of single-mode optical fibers (21₁,21₂), (22₁,22₂), (23₁,23₂),and (24₁,24₂) facing each other. At the end of each of the single-mode optical fibers 21₁-24₂ facing one another, a section of silica fiber without any core 25 and then a section of graded index multimode fiber 26 (GRIN for Graded Index Fiber) are inserted. These fiber sections are inserted by welding them at the ends of the single-mode fibers.

The size of the light spot σ and the working distance δ may be adjusted by changing the length of these two sections. The spot diameter, defined at 1/e² from the intensity peak, may be extended up to 60 μm, with respect to a single-mode fiber width of about 10 μm. The insertion loss between both micro-optics is 0.84 dB including the air gap and a side tolerance (more than □10 μm for 1 dB losses).

The manufacturing process for the micro-optics strip of FIG. 2 requires few steps, and therefore it is very suitable for low cost mass production. The external diameter of the order of 125 μm for the single-mode fibers is maintained along the micro-optic of the strip of FIG. 2, and therefore allows compact packaging. Moreover, large tolerance to alignment errors facilitates the collective assembly of such a strip.

As illustrated in FIG. 2, a working distance δ between about 0 and 1 mm may be obtained with such a micro-optic, enabling a sufficient thickness of PDLC type crystal liquid to be inserted between the ends of each of the pairs of fibers (21₁,21₂), (22₁,22₂), (23₁,23₂),and (24₁,24₂), lengthened with sections 25 and 26, in order to produce an effective optical attenuator.

Moreover, with the micro-optic shown in FIG. 2, a wide spot may be obtained which enhances the diffusing properties of PDLC, as a larger volume of PDLC is thereby crossed by the light beam.

With all these properties, it is therefore possible to design and assemble the strip of FIG. 2 and the optical attenuation system in which it is implemented, and they are well suited to specifications of present telecommunications systems (i.e. low insertion losses, low PDL (Polarization Dependent Loss, etc.) and this at a very low cost.

The micro-optics shown in FIG. 2, which provides extension of the light beam transmitted by the single-mode fibers may be protected and moved from the end of the single-mode fibers so as to thereby facilitate application of surface treatments, such as deposit of electrodes.

A buffer distance may notably be introduced at the end of the fiber as illustrated in FIG. 3. A buffer fiber 31 is inserted at the end of the microoptic formed by the single-mode fiber 22₁, the GRIN fiber 26 and the silica fiber 25, by welding. This buffer fiber, in a preferred embodiment of the invention, is a step index multimode fiber.

Adding such a buffer fiber 31 to the end of the micro-optic may facilitate the method for packaging the constituent fibers of the attenuation device according to the invention.

In fact, the buffer fiber 31 enables a widened mode to be maintained within the expanded core fiber without the length of the latter being critical. Such a property provides simplification of the cleavage of the fiber.

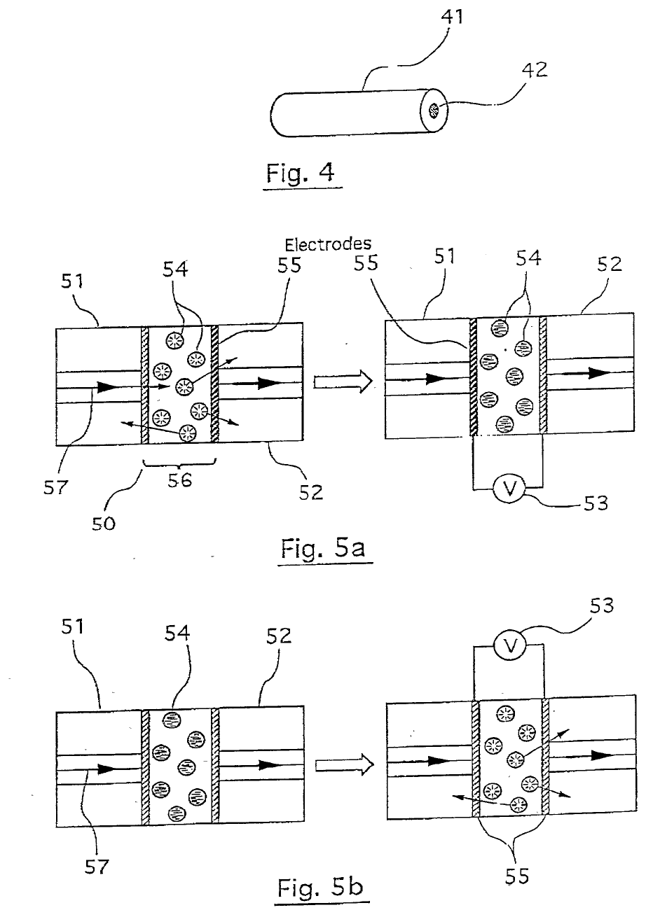

The micro-optic illustrated in FIGS. 2 and 3 forms a first solution for widening the light beam carried by an optical fiber without changing the external diameter of this fiber. A second solution is illustrated in FIG. 4. It consists of changing the optical core 42 of a single-mode fiber 41 by diffusion of the atoms from the doping, by applying a specific heat treatment. A widened mode fiber 41 called a TEC (Thermally diffused Expanded Core) fiber is thereby obtained. Such a fiber 41 is notably presented in the document, “Beam expansing fiber using thermal diffusion of the dopant”, JLT, Vol. 8, No. 8, August 1990, pp. 1151-1161 by Shiraishi et al.

Within the scope of the invention, this expanded core fiber 41 may be cleaved and a liquid crystal cell may be inserted between both of the thereby obtained fiber portions. Both of the expanded core fiber portions obtained by cleavage then form means for widening and means for reducing a section of the light beam respectively, this beam being attenuated upon crossing the intermediate liquid crystal cell.

Henceforth, in connection with FIGS. 5a and 5b, the general principle for the attenuation, controlled by applying an electric field, of an optical beam which crosses a liquid crystal cell of the PDLC type is presented within the scope of the invention.

The optical attenuator 50 is considered. Such an attenuator 50 comprises:

a first expanded core single-mode fiber 51, for widening the section of the light beam;

a PDLC cell 56, wherein droplets 54 of liquid crystal are suspended in a polymer. This cell according to the invention is of an external diameter equal to that of the fiber 51;

a second expanded core single-mode fiber 52, for reducing the section of the light beam attenuated by cell 56, with an external diameter equal to that of fiber 51 and of cell 56.

Fibers 51 and 52 may be TEC type fibers, as illustrated in FIG. 4, or single-mode fibers at the end of which GRIN fiber and silica fiber sections without a core have been inserted by welding, as illustrated in FIGS. 2 and 3.

As mentioned earlier, the orientation of the directors within the droplets 54 is determined by the interactions between the polymer and the liquid crystal at the interface. These orientations are randomly distributed in the absence of an electric field, generally, as illustrated in FIG. 5a. The relative index difference between the liquid crystal and the polymer induces a phenomenon of diffusion. Because the thickness of the cell 56 (typically of the order of 10 μm) is much larger than the size of the droplets 54 (typically of the order of 0.5 to 1 μm), incident light 57 is diffused several times before emerging from cell 56, as illustrated by the arrows in thin lines of FIG. 5a. The importance of the diffusion phenomenon depends on the size, the double refraction and the concentration of the droplets 54.

By controlling the difference between the relative refractive indexes of the liquid crystal and of the polymer, the PDLC 56 may pass continuously from the opaque state to the transparent state. An optical beam 57 incident through fiber 51 is then attenuated because of energy lost by diffusion. In a preferred PDLC layout of the invention, the Mie regime is considered, i.e. a very small index discontinuity between the polymer and the liquid crystal (of the order of δn<<1), for a droplet size 54 comparable with the wavelength of the incident light 57.

The thereby obtained attenuation then follows Beer-Lambert's law:

I(z)=I(0)exp(−2πNa²z) (1)

wherein N is the number of droplets 54 per unit volume, a is the diameter of the droplets (assumed to be of spherical shape) and z the propagation axis. Relationship (1) gives the physical parameters determining the attenuation range of the beam 57. The thickness of the PDLC cell is only limited by the applied voltages.

When a voltage 53 is applied to the terminals of cell 56, the directors of the droplets are orientated in the electric field and the incident beam 57 is no longer diffused. The PDLC is then transparent.

It will be noted that electrodes 55 at the terminals of which voltage 53 is applied are illustrated in FIGS. 5a and 5b. These electrodes may be made with a transparent conducting coating at the ends of fibers 51 and 52. They may also be made by performing at least partial metallization of the periphery of fibers 51 and 52.

FIG. 5b illustrates an optical attenuator similar to the one in FIG. 5a, but wherein the PDLC used is a nematic liquid crystal with negative dielectric anisotropy, in a homeotropic configuration.

Such an optical attenuator 50 has the advantage that the liquid crystal droplets 54 are aligned parallel to the propagation direction of the light beam 57 in the absence of an electric field, i.e., in the rest state.

The attenuator 50 is therefore transparent when the applied voltage 53 is zero, this therefore has operational advantages, notably in terms of energy expenditure. The attenuator 50 switches to an opaque state when a voltage 53 is applied to the terminals of electrodes 55.

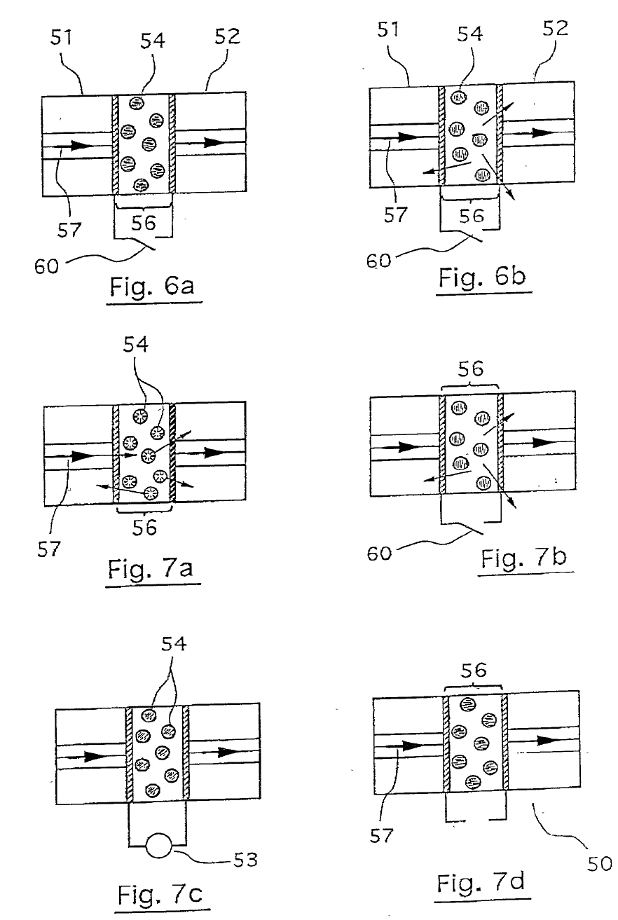

In another embodiment of the invention, control of the PDLC by optical power as illustrated in FIGS. 6a and 6b may also be contemplated.

In FIG. 6a, the optical power to which the PDLC 56 is subject, is of low amplitude. The electrical voltage applied to the terminals of the PDLC 56 is zero as schematized by the open switch 60. The incident beam 57 does not undergo any diffusion when it crosses the PDLC cell 56.

On the other hand in FIG. 6b, the optical power associated with the incident beam 57 is high. The molecules of the droplets 54 are then orientated perpendicularly to the propagation direction of the beam 57, which is strongly diffused upon crossing the cell 56, as illustrated by the divergent arrows in thin lines of FIG. 6b. It will be noted that the voltage applied to the terminals of PDLC 56 is always zero, as illustrated by the open switch 60.

In fact, under intense illumination conditions (typically of the order of several tens of mW per 100 μm²), the incident (high power) electromagnetic wave of any polarization which is perpendicular to the propagation axis of the light beam 57, has the effect of orienting the molecules of the droplets 54 in the same direction. The PDLC 56 then becomes very diffusing. The double refraction maximum is attained in a homeotropic configuration when the liquid crystal is orientated in a plane perpendicular to the light propagation axis.

The optical attenuator 50 then behaves as an optical power limiter, i.e. as a switch which closes automatically when the optical power is very large, according to a behavior similar to that of a Q switch.

The effect illustrated in FIG. 6b, is used when the liquid crystal is in a homeotropic configuration with a positive dielectric anisotropy.

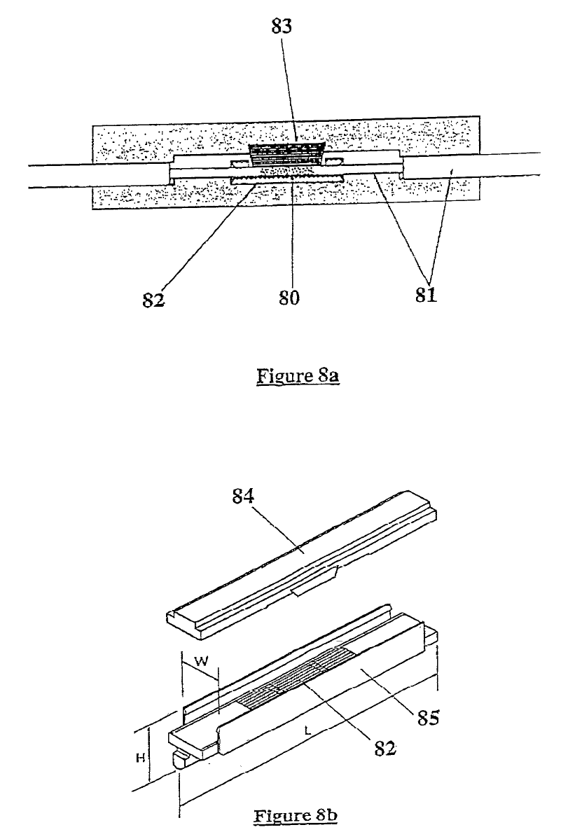

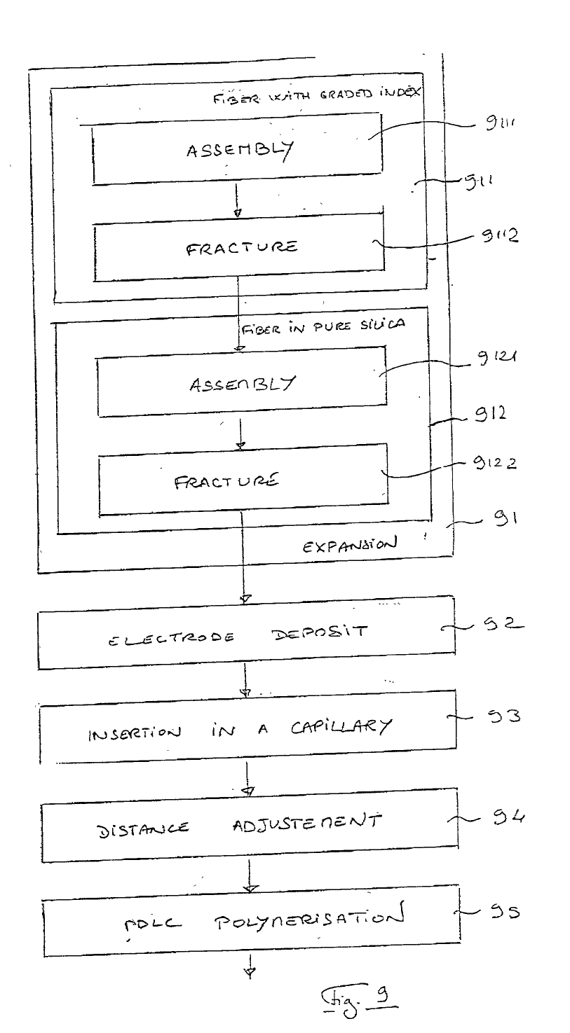

Henceforth, in connection with FIGS. 7a-7d, an embodiment is shown of an optical attenuator according to the invention which simultaneously has both optical and electrical means for controlling the attenuation applied to the incident light beam.

In FIG. 7a, the PDLC 56 of the optical attenuator 50 is in the rest state. The directors of the droplets 54 are randomly orientated in the absence of an electric field. The PDLC 56 is now in an opaque state and attenuates an incident beam 57 by diffusion, as illustrated by the arrows in thin lines of FIG. 7a.

According to the invention, exposure of component 56 to an intense transverse field either optically or electrically, may be contemplated during polymerization of the PDLC. The molecules of the droplets 54 will then all be orientated at rest in a plane perpendicular to the propagation axis of the light beam 57, and according to the polarization vector of the incident wave.

Thus, when the PDLC 56 is exposed to a strong optical field during its polymerization, an optical attenuator 50 is obtained, which at rest has an optimum opaque state, as illustrated in FIG. 7b: the directors are orientated perpendicularly to the propagation axis of the light beam, the amplitude of the diffusion phenomenon (schematized by arrows in thin lines) is maximum.

If, on the other hand, the PDLC 56 is subject to a strong electric field during polymerization, an optimum transparent state of the attenuator 50 is obtained at rest wherein the molecules of the droplets are aligned in the direction of propagation of the incident light beam 57, as illustrated in FIG. 7d.

When an optical attenuator, having a configuration at rest similar to that of FIG. 7d, is subject to high optical power, the directors of the droplets 54 tend, under the effect of the optical field, to be oriented in a configuration perpendicular to the direction of propagation of the beam 57, as illustrated in FIG. 7b. An optical power limiting device is then achieved.

When an optical attenuator, having a configuration at rest similar to that of FIG. 7b, is subject to an electrical voltage, the directors of the droplets 54 tend, under the effect of the electric field, to be orientated in the direction of propagation of the beam 57. A variable optical attenuator is then achieved.

When simultaneous control both by optical power and by an electric field is contemplated as illustrated in FIG. 7c, the liquid crystal droplets 54 suffer from the antagonist effect of both fields due to the optical wave and to the applied voltage 53 and they align according to the vector resultant of both of these fields.

However, it should be noted that the device is in a regime of the power limiter type, basic control of the device is performed by the optical power, applying a voltage will only counterbalance this effect. Conversely, when the device according to the invention is in a configuration of the variable optical attenuator type, basic control is performed by the voltage applied to the terminals of the PDLC cell, the influence of optical power only allows this effect to be counterbalanced.

With this property of PDLC cells of being able to be simultaneously controlled both by optical power and electrical voltage, large dynamic range attenuators may be produced.

Henceforth, in connection with FIGS. 8a and 8b, examples of supports are shown onto which an optical attenuator according to the invention may be integrated.

As shown earlier, an optical attenuator according to the invention has a simple assembly structure and consists of two expanded mode fibers facing each other and of a liquid crystal inserted in the cavity formed between these two fibers. The electric field for controlling the attenuation level is applied to the liquid crystal via fibers, for example by depositing transparent electrodes on the latter. An optical control of the attenuation level is also possible via illumination of the liquid crystal. The whole of this attenuation device is integrated into a support, which moreover may group together several power limiters or attenuators. Collective realization is therefore possible for reducing manufacturing costs. An example of a support is shown in FIGS. 8a and 8b.

As illustrated in FIG. 8a, such a support holds an optical fiber 81, into which a PDLC cell 80 has been inserted according to the technique described earlier. It notably comprises a contact 83 and a microcapillary 82.

The exploded view of a support shown in FIG. 8b shows the body of the support 85, the upper portion of the support 84 and the microcapillary 82.

II. Manufacturing Process According to the Invention

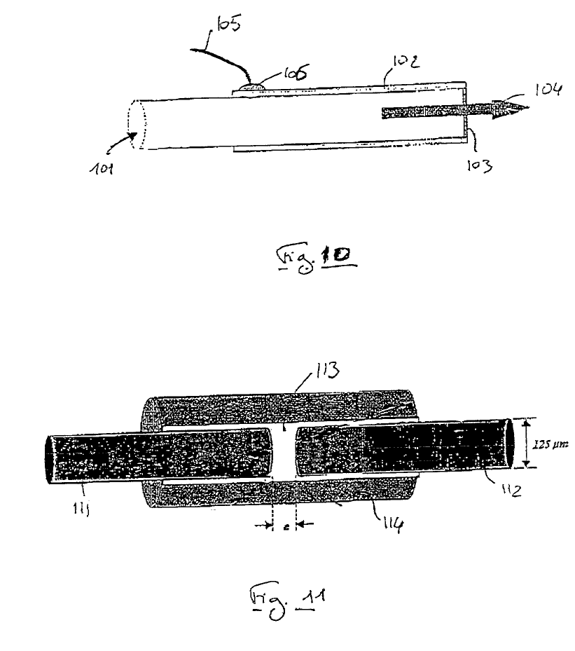

FIG. 9 is a simplified flowchart illustrating the manufacturing process of the VOA devices such as described above. As will be seen below, this process is simple and efficient, and in particular makes it possible to limit optical losses, compared with prior art techniques.

According to the invention, first of all one provides an expansion stage 91 of the optical core of two fibers. In order to do this, one assembles 9111, 9121, and then fractures 9112, 9122, portions of fiber at the end of the single-mode fiber.

This assembly can be an assembly of sections of fiber in pure silica 912 and of fiber with graded index 911. A variant of this assembly can be the addition of a section in pure silica and/or a section of multimode fiber at the end of said fibers. An alternative to this optical core expansion is the use of thermal diffusion technology for the dopants of the single-mode fiber.

Thus, the ends of the fibers are cleaved, and not sawn. The condition of the surface is thus improved, and no pollution is generated.

Then, one carries out an electrode deposit 92, by metallization of the periphery of the fiber as well as of its end.

The present invention thus provides a metallic deposit at the end of an optical fiber. This deposit has the particularity of being metallic in order to ensure electric conduction and at the same time to be optically transparent to the electromagnetic fields propagating in the optical fiber. This deposit is obtained by cathodic pulverization.

A thick metallization is made around the periphery of the fiber to carry an electric voltage at the end of the fiber. This voltage makes it possible to control the attenuation level of the variable attenuator. The end of the fiber is also given a metallic deposit which is electrically conductive and at the same time optically transparent. This end will be directly in contact with the PDLC and will be crossed by the light beam. These are the reasons why its deposit must be conductive and transparent.

A variant to the utilization of a metallic deposit is the utilization of an ITO deposit (Indium Tin Oxide).

FIG. 10 shows a fiber at this moment in manufacturing. The optical fiber 101 is covered with a thick metallic deposit 102 around the periphery and with a transparent and conductive metallic deposit 103 at the end, allowing the light beam 104 to pass. An electric wire 105 is connected to the metallic deposit 102 via an electric contact 106, to enable control of the device.

Two fibers thus obtained are inserted 93 in a capillary containing PDLC, as shown in FIG. 11. The assembly of the optical attenuator thus consists of aligning two of these fibers 111 and 112 (metallized with expansion of the optical core) facing each other with the PDLC 113 between them. The innovation of this optical attenuator resides notably in the utilization of a capillary 114 (precision tube).

The fibers are introduced at each end of the capillary. The precision alignment of the optical cores of the fibers is thus optimized and simple. Before the introduction of the optical fibers, the capillary is filled with PDLC. This is another advantage of the capillary 114, being at the same time both the alignment agent for the fibers and the reservoir for the PDLC.

Particularities of this capillary are configurations with or without a radial hole for evacuating excess PDLC, the depth and inclination of the icons for introducing the fibers, and the nature of the material composing it. Optionally, it is in glass.

One adjusts 94 then the distance (c) between the two ends of the fibers facing each other. The optical function of the variable attenuator is carried out by the PDLC. Its thickness between the fibers facing each other therefore has great importance for the optical quality of the attenuator.

In fact, it is within this distance between fibers that the optical beam will propagate freely and undergo diffusion. This level of diffusion can be controlled by the electrical voltage. In particular it can be transparent if no diffusion is apparent or highly attenuating if the diffusion is high. It is thus even more understandable that the adjustment of its thickness has an importance for the properties of the attenuator. The capillary makes the adjustment of this thickness simple.

Finally, the PDLC is polymerized 95 by ultraviolet radiation.

The PDLC is a mixture of materials under liquid form before polymerization. This property facilitates its introduction into the capillary and the adjustment of the space between the optical fibers in said capillary. In order to obtain the optical properties of diffusion, it is necessary to polymerize this liquid mixture to transform it into a soft agglomerate. This polymerization is carried out with UV radiation.

As an alternative, temperature is another solution for polymerization. This soft agglomerate has optical qualities which are different depending on the power, the energy, the wavelength and the manner of exposing this zone between fibers. By manner of exposing, or exposures, one means radial, axial, and their combinations of exposures.

Although the present invention has been described with reference to preferred embodiments, workers skilled in the art will recognize that changes may be made in form and detail without departing from the spirit and scope of the invention

What is claimed is:

1. Process for manufacturing an attenuation device for a signal carried by an optical fiber in the form of a light signal, characterized in that it comprises the following stages:
expansion of the optical core of a first and a second single-mode fiber;
assembly of said first and second fibers facing each other, in a capillary containing a liquid crystal;
polymerization of said liquid crystal, to produce an attenuation element.

2. Process for manufacturing an attenuation device according to claim 1, characterized in that it comprises, after said expansion stage, a stage of:
depositing an electrode over at least one portion of the periphery and over at least one portion of the end of each of said fibers.

3. Process for manufacturing an attenuation device according to claim 1, characterized in that said expansion stage comprises a stage of assembly and fracture of at least two portions of fiber at the end of each of said single-mode fibers.

4. Process for manufacturing an attenuation device according to claim 3, characterized in that said portions of fiber comprise a portion of fiber with graded index and a portion of fiber in pure silica.

5. Process for manufacturing an attenuation device according to claim 1, characterized in that said liquid crystal is a liquid crystal dispersed in a polymer (PDLC).

6. Process for manufacturing an attenuation device according to claim 5, characterized in that said polymer dispersed liquid crystal is a nematic liquid crystal with negative anisotropy.

7. Process for manufacturing an attenuation device according to claim 1, characterized in that said polymerization stage implements a polymerization of said liquid crystal dispersed in a polymer by ultra-violet radiation.

8. Process for manufacturing an attenuation device according to any one of claims 1 to 7, characterized in that it comprises the following stages:
expansion of the optical core of two fibers by assembly and fracture of a fiber with graded index and of pure silica;
metallization of the periphery and the end of said fibers;
insertion of a first and a second of said fibers facing each other in a capillary containing a liquid crystal;
adjustment of the distance between the ends of said fibers facing each other;
polymerization of said liquid crystal by ultraviolet radiation.

9. Process for manufacturing an attenuation device according to claim 1, characterized in that at least one part of the ends of said fibers facing each other is conductive and substantially transparent.

10. Process for manufacturing an attenuation device according to claim 1, characterized in that a buffer block of step index multimode fiber is added to each of said ends of said first and second fibers facing each other, said block having an external diameter substantially equal to that of said first and second fibers.

11. Process for manufacturing an attenuation device according to claim 1, characterized in that said expansion stage comprises a stage of diffusion of dopants from the optical core of a cleaved single-mode fiber.

12. Process for manufacturing an attenuation device according to claim 1, characterized in that said single-mode fibers with expanded core are polarization preserving fibers.

13. Process for manufacturing an attenuation device according to claim ¹, characterized in that it comprises a stage for inserting means for controlling said attenuation means by an optical field.

14. Attenuation device manufactured according to the process of claim 1.

15. Attenuation device of a signal carried by an optical fiber in the form of a light beam, characterized in that it comprises a first and a second single-mode fiber with expanded optical core assembled facing each other in a capillary containing a liquid crystal forming attenuation means.

16. Attenuation device according to claim 15, characterized in that at least one portion of the periphery and at least one portion of the end of each of said fibers is metallized.

17. Attenuation device according to claim 15, characterized in that the ends of said fibers are obtained by fracture.

18. The attenuation device according to claim 15 implemented in a power limiter which can be controlled by optical power.

19. The attenuation device according to claim 15 implemented in a variable attenuator which can be voltage controlled.

20. The attenuation device according to claim 15, further including at least a second attenuation device for attenuating a signal carried by an optical fiber in the form of a light beam, the second attenuation device being characterized in that it comprises a first and a second single-mode fiber with expanded optical core assembled facing each other in a capillary containing a liquid crystal forming attenuation means, the first and second attenuation devices being further characterised in that the fibers of said at least two attenuation devices are positioned as a strip of fibers.
